(19) United States
(12) Patent Application Publication
(10) Pub. No.: US 2016/0257579 A1
(43) Pub. Date: Sep. 8, 2016

(54) SYSTEM AND METHOD FOR REMOVAL AND ERADICATING RESIDUAL OIL FROM PRODUCED WATERS

(71) Applicant: Keith A. Langenbeck, Ennis, TX (US)

(72) Inventor: Keith A. Langenbeck, Ennis, TX (US)

(21) Appl. No.: 15/051,855

(22) Filed: Feb. 24, 2016

Related U.S. Application Data
(60) Provisional application No. 62/129,926, filed on Mar. 8, 2015.
(60) Provisional application No. 62/208,793, filed on Aug. 23, 2015.

(51) Int. Cl. C02F 1/38; B04B 7/12; C02F 1/30; B04B 5/10; C02F 1/04; C02F 1/78

(52) U.S. Cl. CPC C02F 1/385; C02F 1/048; C02F 1/78; C02F 1/305; B04B 5/10; B04B 7/12; C02F 2101/12

(57) ABSTRACT

A system for processing oilfield produced water comprises an onsite non-turbulent fractioning centrifuge configured to pretreat the produced waters and remove emulsified oil therefrom to generate de-oiled water. The centrifuge comprises separating a heavier component from a lighter component within a mixed fluid via a separator chamber, a stack of driven flat discs, a disc shaft rotator, a first outlet for the heavier component and a second outlet for the lighter component and a feed pump that supplies raw fluids to the separator. Also included, is an onsite means to eradicate remaining petroleum hydrocarbons and related contaminants and generate oil-free water thereby. An onsite water demineralizer generates potable water from the oil-free water. A system for separating and processing oilfield produced water further comprises an aggregate tank battery configured to collect raw fluids from wells and pipelines and separate crude oil and produced waters via gravity.

### CROSS-REFERENCE TO RELATED APPLICATIONS

This application claims the benefit of the priority date of earlier filed U.S. Provisional Utility Application Ser. No. 62/129,926 titled “Removal and Eradicating Residual Oil From Produced Waters,” filed Mar. 8, 2015 for Keith A. Langenbeck, and U.S. Provisional Utility Application Ser. No. 62/208,793 titled “Oilfield Water Remediation and Petroleum Processing System,” filed Aug. 23, 2015 for Keith A. Langenbeck, each incorporated herein by reference in its entirety.

### BACKGROUND AND FIELD OF INVENTION

The product of the oil & gas industry may be hydrocarbons, but water is a key element of economic significance in oilfield production. Contaminated (‘associated’ or ‘produced’) water is a toxic byproduct brought to the surface along with the hydrocarbon product from geological formations. Produced water inevitably contains a variety of contaminants, depending on the geological environment from which it is extracted, the manner in which it is produced, is frequently very corrosive, and may include dissolved or emulsified hydrocarbons, toxic chemical compounds used in certain production methods like fracking, various minerals and metals.

This disclosure concerns the application of certain technologies individually and as a system that result in the affordable and effective conversion of oil field produced waters into potable equivalent fresh water, the pre-processing of certain petroleum product, the utilization of certain petroleum products within the system and other value added functions accomplished within or nearby the producing oil/natural gas fields.

Considerable quantities of water are consumed in drilling operations, completion/fracking processes and re-stimulation of oil/natural gas wells. Much more than the desired petroleum recovered from underground, vast amounts of ‘produced water’ arise commingled during the productive life of the well. In 2009 the Argonne National Laboratory/NETL reported that 21 billion barrels (˜42 gallons to a barrel) of produced water were generated in the United States alone. This does not take into account the considerable growth in domestic oil and natural gas production in the past 7 years or that oil/natural gas wells typically produce less petroleum and more water into maturity.

The predominant method for disposing oil field waste water is re-injection into isolated, deep underground formations of similar geology and chemical composition as the disposal water. Depending on the composition, some waste waters are pretreated but usually not. Produced waters commonly retain a small amount of crude oil (½ to 2% by volume emulsified in the carrier water) that does not settle out at well site tank batteries. With Water-Oil-Ratios in the United States being as high as 10:1, the recovery of this small percentage ‘lost oil’ can represent a significant contribution to the economic life of production operations.

Although some oil fields have on-site disposal wells, most of the produced water is loaded into tanker trucks, driven to a third party disposal well operation and then injected down hole. The cost for off-site disposal varies by region from just under $1/barrel in the Permian Basin to as much as $5-9/barrel in the Marcellus Shale. Texas, Louisiana, Oklahoma and other historic oil producing states have acceptable geology and many nearby re-injection wells for lower cost disposal of produced waters. The Marcellus Shale in Pennsylvania and surrounding states does not. Much of its produced water is shipped by truck or train to Ohio and West Virginia for re-injection.

There is a long felt need for an affordable and effective conversion of oilfield produced waters into potable equivalent fresh water that has gone unmet until the present Applicant's disclosure.

### SUMMARY OF THE INVENTION

A system for processing oilfield produced water comprises an onsite non-turbulent fractioning centrifuge configured to pretreat the produced waters and remove emulsified oil therefrom to generate de-oiled water. The non-turbulent fractioning centrifuge comprises separating a heavier component from a lighter component within a mixed fluid via a stack of driven flat discs, a separator chamber, a disc shaft rotator, a first outlet for the heavier component and a second outlet for the lighter component and a means for feeding (feed pump) that supplies the mixed fluid to the separator. The relative closeness of the discs and the frictional relationship between the fluid and the disc surface create conditions which prevent the local churning of the fluids while moving through the machine. The system also includes an onsite means, such as high energy electron beams, ozone generators or other methods, to eradicate in situ the remaining petroleum hydrocarbons and related contaminants resulting in oil-free water thereby. The system additionally includes an onsite means, such as reverse osmosis and other demineralization methods, configured to generate potable water from the oil-free water.

A system is disclosed for separating and processing oilfield produced water. The system comprises an aggregate tank battery configured to collect raw fluids from a number of wells and pipelines and separate crude oil and produced waters by gravity. The separating and processing system also includes a non-turbulent fractioning centrifuge configured to pretreat the produced waters and remove emulsified oil therefrom to generate de-oiled water. Additionally, means such as a high energy electron beam, ozone generator or other methods are configured to generate oil-free water by eradicating the remaining petroleum hydrocarbons and related contaminants thereby. Furthermore, water demineralization means, such as reverse osmosis or other methods are configured to generate potable water from the oil-free water.

A method for separating and processing oilfield produced water includes collecting into an aggregate tank battery, raw or unprocessed fluids from a number of wells and pipelines and separate crude oil and produced waters as a result of gravity. The method also includes pretreating the produced waters via a non-turbulent fractioning centrifuge configured to remove emulsified oil therefrom to generate de-oiled water. The method additionally includes eradication of remaining petroleum constituents and related contaminants by exposing the de-oiled water to high energy electron beams and ozone in situ.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 is a block diagram illustrating interconnections for an aggregated tank Battery and non-turbulent fractioning centrifuge processing of Produced waters in accordance with an embodiment of the present disclosure.

FIG. 2 is a block diagram illustrating interconnections for a non-turbulent fractioning centrifuge separation of Methane and Natural Gas Liquids for conversion to electricity, heat and pipeline distribution in accordance with an embodiment of the present disclosure.

FIG. 3 is a block diagram illustrating interconnections, hydrocarbon eradication and related contaminant from the de-oiled water, followed by demineralization of the oil free water and further non-turbulent fractioning centrifuge processing of Stabilized Crude Oil in accordance with an embodiment of the present disclosure.

FIG. 4 is a flow diagram of a method for separating and processing oilfield produced water via a non-turbulent fractioning centrifuge, in situ eradication of residual hydrocarbon constituents and related contaminants from the de-oiled water resulting in oil-free water and water demineralization of oil-free water in accordance with an embodiment of the present disclosure.

FIG. 5 is a depiction of the non-turbulent fractioning centrifuge component of the system for separating and processing produced waters and crude oil in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure, use of the term ‘onsite’ refers to a location for field processing where fluids are aggregated from multiple oil wells. Additionally, the term ‘aggregate’ refers to collected fluids for processing onsite in the field. Furthermore, whenever the term, “centrifuge” is used by itself, it is implied to be a non-turbulent fractioning centrifuge as claimed herein and by U.S. Non-provisional Patent No. 8397918 B2 sharing the same inventor applicant as the present application. The terms ‘raw fluid’ and ‘mixed fluid’ are treated synonymously herein to refer to fluids including hydrocarbons and water and other fluids associated with oil wells which have not yet been processed for separation.

Therefore, the non-turbulent fractioning centrifuge comprises a separator including (i) a plurality of discs that are spaced apart along a disc axis; (ii) a separator chamber that encircles the plurality of discs, the separator chamber including a chamber inlet that receives the mixed fluid, a first outlet and a second outlet; and (iii) a disc shaft rotator that rotates the plurality of discs about the disc axis so that the mixed fluid entering the separator chamber is spun around the separator chamber about the disc axis to separate the heavier second from the first component and direct the first component out of the first outlet and the second component out of the second outlet.

The non-turbulent fractioning centrifuge also comprises means, such as a feed pump or gravity feed tank that supplies the mixed fluid to the separator as needed. The feed pump includes a pump shaft and a plurality of spaced apart pump discs that are secured to the pump shaft, and wherein rotation of the pump shaft results in rotation of the pump discs.

The heretofore unsolved roadblock in on-site produced water remediation is effective, affordable pretreatment that first recovers the small percentage lost oil emulsified in the produced water and then eliminates essentially 100% of any and all residual petroleum products and related contaminants before demineralization/desalination processing. Effective and affordable pre-treatment of the produced water by Fractioning Centrifuge, U.S. Pat. No. 8,397,918B2, would be the primary technology used in removing emulsified oil in produced water. Non-turbulent centrifuge treatment of the oil field produced water increases the efficiency and productivity of separating the residual, small percentage oil concentrations from the base water. Effective pretreatment of the produced water would dramatically reduce the size, power requirements and cost of the in situ eradication of the remaining hydrocarbons and related contaminants.

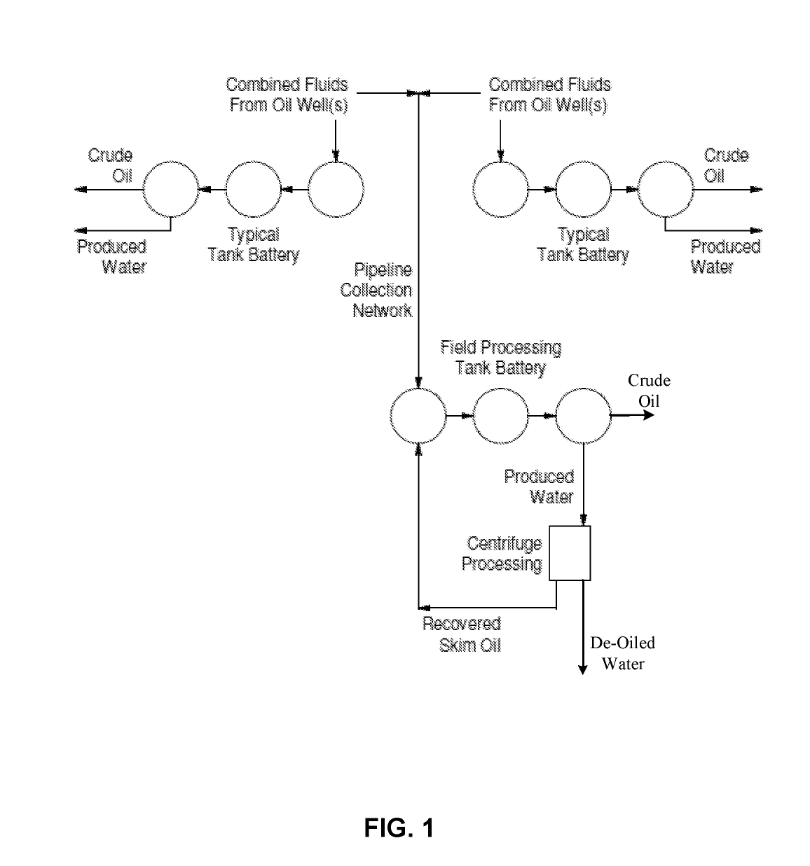

FIG. 1 is a block diagram illustrating interconnections for an aggregated tank Battery and non-turbulent fractioning centrifuge processing of Produced waters in accordance with an embodiment of the present disclosure. Typical oil field operations include tank batteries that aggregate the fluid output of one or a small number of nearby wells. The tank battery is regularly serviced to collect the gravity separated crude oil for sale and remove the produced water for disposal. Frequently, the tank batteries include pre-processing equipment, like heater treaters, to ameliorate the amounts of methane and natural gas liquids that can arise mixed with the crude oil. If the amount of methane/C1 and natural gas liquids (ethane/C2, propane/C3, butane/C4, pentane/C5) exceeds the capability of the tank battery and its pre-processing equipment, it is vented to atmosphere and ignited. The flaring of excess methane and natural gas liquids represents a loss of valuable energy products and significant air pollution problem throughout the oil industry, but especially in the Bakken Shale field.

Different than conventional, passive hydrocyclones, the fractioning centrifuge uses a stack of driven flat discs to generate the separating vortex. The relative closeness of these discs and the friction relationship between the fluid and the disc surface (boundary layer conditions) prevents the local churning of the fluids while moving through the machine. This non-turbulent flow state facilitates the separation of the emulsified oil from water. The rotational speed of the flat discs and the disc diameter can result in just over 4,000 G's calculated.

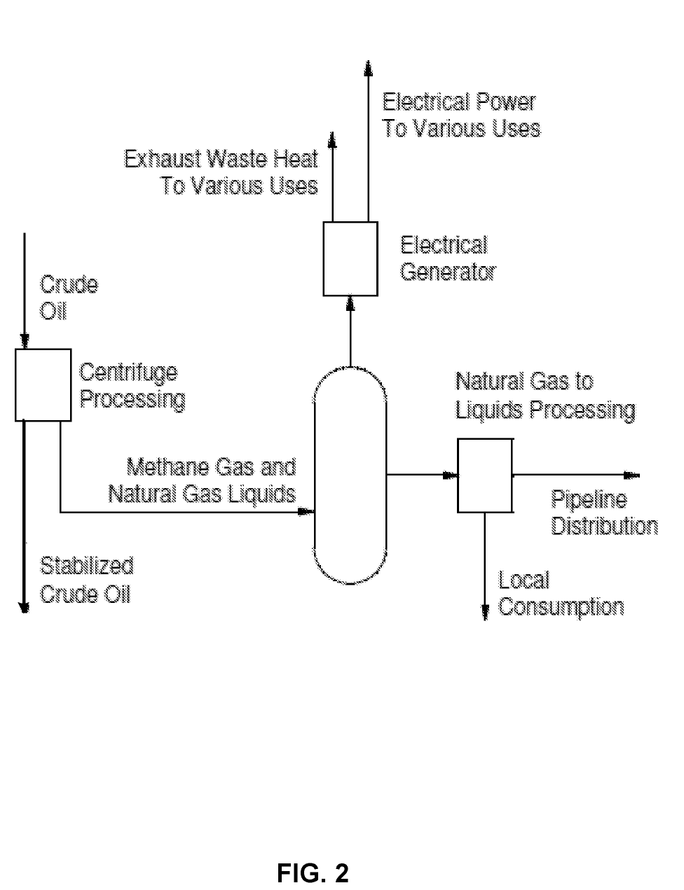

FIG. 2 is a block diagram illustrating interconnections for a non-turbulent fractioning centrifuge separation of Methane and Natural Gas Liquids for conversion to electricity, process heat and pipeline distribution in accordance with an embodiment of the present disclosure. A produced water remediation system, utilizing non-turbulent centrifugation and complete hydrocarbon eradication with no external added chemicals, requires electrical power to accomplish the intended outcome. Oil and natural gas fields are typically remote and require electrical power lines to be run considerable distance at considerable cost. The need to remediate large quantities of produced water and requisite power to do so presents an unique opportunity for in-field generation of that electrical power and other value added processes.

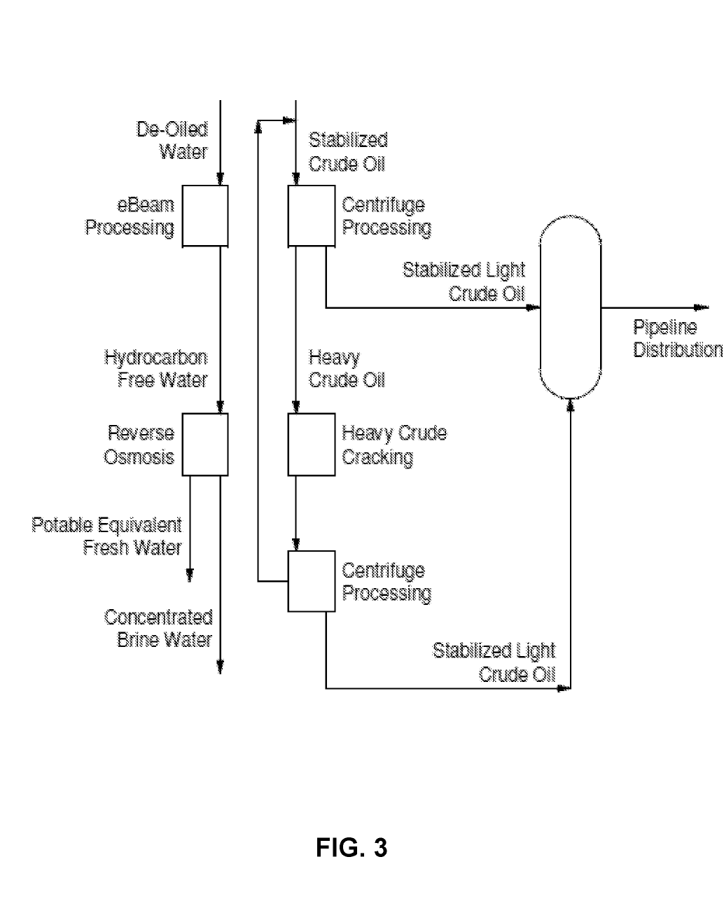

FIG. 3 is a block diagram illustrating interconnections for hydrocarbon and related contaminant eradication beam and demineralization processing of the de-oiled water and further non-turbulent fractioning processing of Stabilized Crude Oil in accordance with an embodiment of the present disclosure. Complete eradication of any remaining petroleum constituents in the de-oiled water, whether emulsified or dissolved, would be by high energy electrons and secondary ozone generated by an electron beam. The use of ozone generators and other non-chemical technologies for eradicating any remaining petroleum constituents, different or apart from electron beam or in conjunction with electron beam, are also anticipated in this disclosure. Citation of electron beam, aka eBeam, as a preferred method for hydrocarbon eradication is not a limitation hereto. Complete eradication of any and all petroleum products and related contaminants in pretreated produced water allows for affordable, commercial-off-the-shelf demineralization technology like reverse osmosis to be employed and potable water to be produced therefrom.

In an embodiment of the disclosure the above block diagrams of FIG. 1, FIG. 2 and FIG. 3 are interconnected and interrelated. The de-oiled water output from the centrifuge processing of FIG. 1 is input to the hydrocarbon eradication processing of FIG. 3. Also, the crude oil output from the Field Processing Tank Battery is input to the centrifuge processing of FIG. 2. Additionally, the Stabilized Crude Oil output from the centrifuge of FIG. 2 is input to the centrifuge processing of FIG. 3 to produce a stabilized light crude oil. Each figure is also intra-related. For instance the produced water from a typical tank battery may be input with the produced water from the field processing tank battery into the Centrifuge processing.

In various disclosed embodiments, eliminating individual tank batteries and aggregating the raw fluids by local pipelines to in-field processing operations offers significant cost savings and other value added functions. Among the potential benefits would be: (1) produced water collection without truck transport, (2) separation of methane and natural gas liquids (aka crude stabilization) from the raw crude to fuel electrical generators, (3) kilowatt generation without the infrastructure cost of bringing power out to the field, (4) on site generation of kilowatts used to power waste water remediation system, (5) on site generation of kilowatts distributed to the pump jacks for use at the well sites, (6) on site generation of kilowatts used for pumping the fluids from the well sites to the processing site, (7) on site generation of kilowatts used for other in-field processing operations such as natural gas conversion to liquids, (8) on site generation of kilowatts used for centrifuge fractioning of lighter weight crude from heavier weight crude, (9) on site generation of kilowatts used for cracking heavier weight lower value crude into lighter weight higher value crude, (10) utilizing waste heat from the electrical generation to facilitate separation of raw crude from the produced water, (11) utilizing waste heat from the electrical generation to facilitate separation of the methane and natural gas liquids from the raw crude, (12) utilizing waste heat from the electrical generation to facilitate separation of lighter crude fraction from heavier crude fraction, (13) utilizing waste heat from the electrical generation to facilitate demineralization of de-oiled produced water in vapor condensation process(es), (14) internally generated fresh water available for on-going oil field operations like drilling and fracking, (15) sale of internally generated fresh water to third party oil operations, (16) sale of produced water remediation services to third party oil operations, (17) sale or use of internally generated fresh water in agriculture, (18) sale of excess kilowatts directly to others or into the grid and (19) other potential uses of kilowatts, fresh water and excess heat that could come from processing the aggregated raw fluids of oil and natural gas production, as described herein.

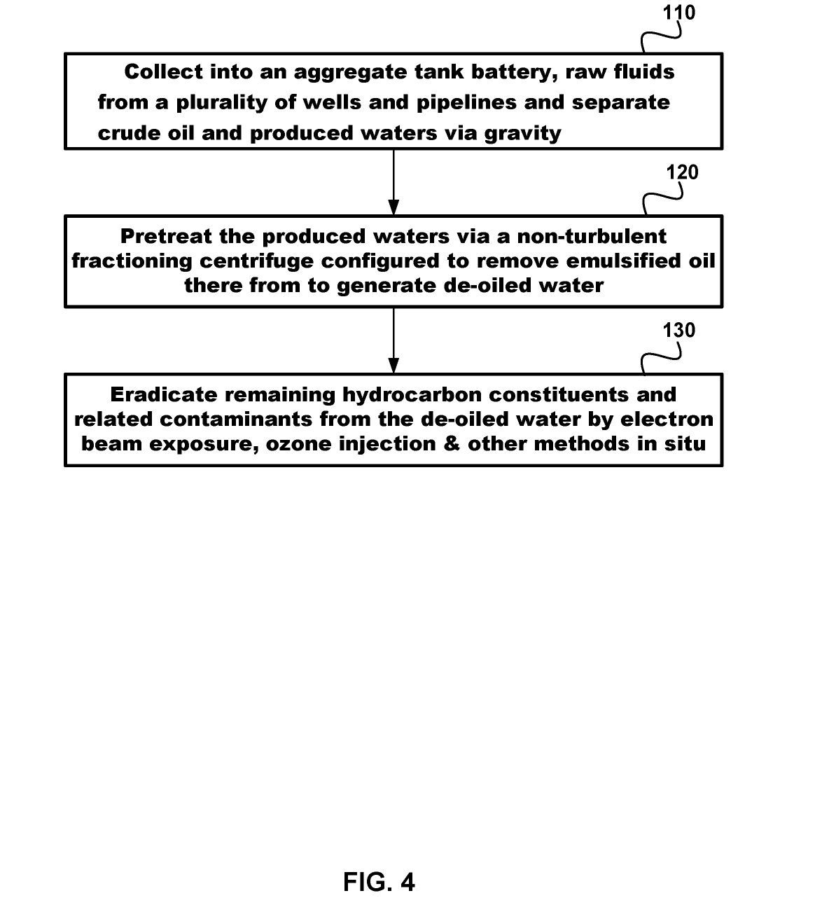

FIG. 4 is a flow diagram of a method for separating and processing oilfield produced water via a non-turbulent fractioning centrifuge, electron beam processing and reverse osmosis processing in accordance with an embodiment of the present disclosure. A method for separating and processing oilfield produced water comprises 110 collecting into an aggregate tank battery, raw or unprocessed fluids from a number of wells and pipelines and separate crude oil and produced waters as a result of gravity. The method also includes 120 pretreating the produced waters via a non-turbulent fractioning centrifuge configured to remove emulsified oil therefrom to generate de-oiled water. The method additionally includes 130 generating ozone in the de-oiled water and eradicate remaining petroleum constituents and related contaminants thereby.

An embodiment of the disclosed method further comprises the non-turbulent fractioning centrifuge removing a high percentage of the emulsified oil from the produced waters to produce the de-oiled water. This has the advantage of reducing the amount of ozone necessary to eradicate residual petroleum constituents and related contaminants in the de-oiled water before being processed as oil-free water by the demineralization technology. The oil-free water has the advantage of avoiding the smearing of oil along the reverse osmosis membranes rendering them non-functional.

Another embodiment of the method is disclosed further comprising separating a heavier component from a lighter component within the raw fluids via a non-turbulent fractioning centrifuge comprising a stack of driven flat discs, a separator chamber, a disc shaft rotator, a first outlet for the heavier component and a second outlet for the lighter component and means (feed pump) to supply the raw fluid to the separator. A relative closeness of the discs and a frictional relationship between the fluids and a disc surface (boundary layer conditions) adapted for preventing the local churning of the fluids while moving through the machine.

The disclosed system and full scale fractioning centrifuge and other disclosed components may be trailer mounted with various tanks, pumps, plumbing and miscellaneous equipment for field collection and remediation of oil field waters. The effectiveness of the fractioning centrifuge in removing the small percentage, tight emulsion in produced water has numerous other applications for breaking other tight emulsions or liquid-liquid mixtures. One potentially significant application of liquid-liquid separation would be the removal of Natural Gas Liquids from Shale crude oil at the well site without conventional distillation methods.

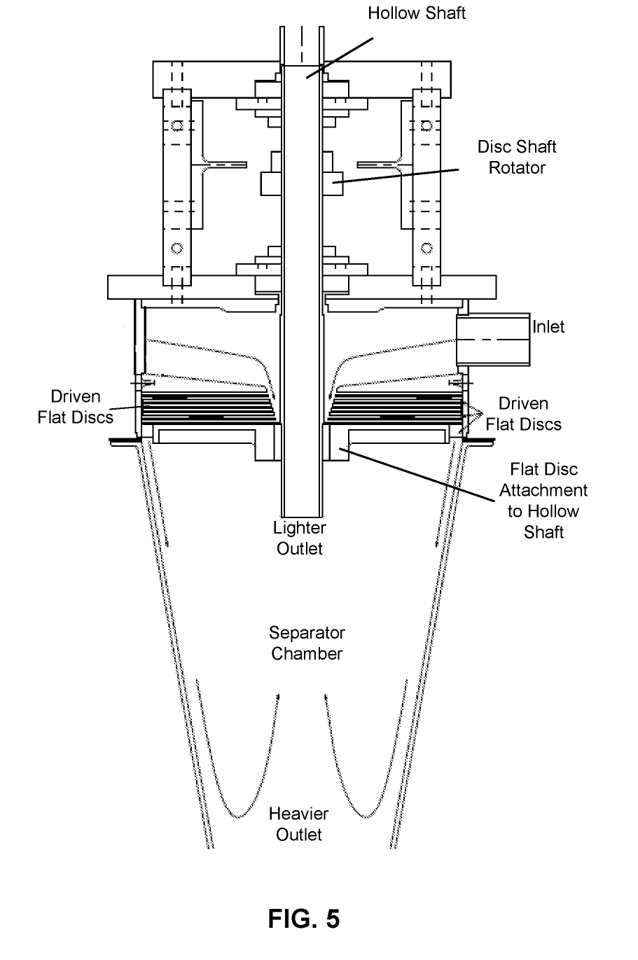

FIG. 5 is a depiction of the non-turbulent fractioning centrifuge component of the system for separating and processing produced waters and crude oil in accordance with an embodiment of the present disclosure. The depiction includes a hollow shaft rotator for a hollow shaft, an inlet, driven flat discs, a flat disc attachment for the hollow shaft, a lighter outlet and a separator chamber. The non-turbulent fractioning centrifuge separates a heavier component from a lighter component within the raw fluids via a stack of driven flat discs, a separator chamber, a disc shaft rotator, a first outlet for the heavier component and a second outlet for the lighter component and means to feed the raw fluid to the separator. A relative closeness of the discs and a frictional relationship between the fluids and a disc surface creates boundary layer conditions adapted for preventing the local churning of the fluids while moving through the machine.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A system for processing oilfield produced water, the system comprising:
an onsite non-turbulent fractioning centrifuge configured to pretreat the produced waters and remove emulsified oil therefrom to generate de-oiled water;
an onsite device configured to generate oil-free water from the de-oiled water by eradicating remaining petroleum hydrocarbons and related contaminants thereby; and
an onsite demineralizer configured to generate potable water from the oil-free water.

2. The system of claim 1, wherein the site is located at an aggregate tank battery configured to collect raw fluids from a plurality of wells and pipelines and separate crude oil and produced waters via gravity.

3. The system of claim 1, further comprising an aggregate tank battery configured to collect raw fluids from a plurality of wells and pipelines and separate crude oil and produced waters via gravity.

4. The system of claim 1, wherein the non-turbulent fractioning centrifuge comprises a separator including (i) a plurality of discs that are spaced apart along a disc axis; (ii) a separator chamber that encircles the plurality of discs, the separator chamber including a chamber inlet that receives the mixed fluid, a first outlet and a second outlet; and (iii) a disc shaft rotator that rotates the plurality of discs about the disc axis so that the mixed fluid entering the separator chamber is spun around the separator chamber about the disc axis to separate the heavier second from the first component and direct the first component out of the first outlet and the second component out of the second outlet.

5. The system of claim 2, wherein the non-turbulent fractioning centrifuge comprises a feed pump that supplies the mixed fluid to the separator, the feed pump including a pump shaft and a plurality of spaced apart pump discs that are secured to the pump shaft, and wherein rotation of the pump shaft results in rotation of the pump discs.

6. The system of claim 1, wherein the non-turbulent fractioning centrifuge is a laminar flow gravity force centrifuge.

7. A system for separating and processing oilfield produced water, the system comprising:
an aggregate tank battery configured to collect raw fluids from a plurality of wells and pipelines and separate crude oil and produced waters via gravity;
a non-turbulent fractioning centrifuge configured to pretreat the produced waters and remove emulsified oil therefrom to generate de-oiled water;
a device configured to eradicate the remaining petroleum hydrocarbons and related contaminants from the de-oiled water and generate oil-free water thereby; and
a demineralizer configured to generate potable water from the oil-free water.

8. The system of claim 7, further comprising a high energy electron beam configured to generate ozone in the de-oiled water and eradicate remaining petroleum hydrocarbons and related contaminants thereby.

9. The system of claim 7, further comprising an onsite electrical power distribution to a plurality of pump jacks at various well sites and to pumps for pumping fluids from the various well sites to a processing site.

10. The system of claim 7, wherein the non-turbulent fractioning centrifuge, the device configured to generated oil-free water and the device configured to demineralize the oil-free water are all adapted to operate on electricity generated onsite.

11. The system of claim 1, wherein the aggregate tank battery comprises a processing site for the system, the aggregate tank battery configured to collect raw fluids from a plurality of wells and pipelines and separate crude oil and produced waters via gravity.

12. The system of claim 1, wherein the non-turbulent fractioning centrifuge is configured to separate a heavier component from a lighter component within the raw fluids via a stack of driven flat discs, a separator chamber, a disc shaft rotator, a first outlet for the heavier component and a second outlet for the lighter component and a feed pump that supplies the raw fluids to the separator.

13. A method for separating and processing oilfield produced water, the system comprising:
collecting into an aggregate tank battery, raw fluids from a plurality of wells and pipelines and separate crude oil and produced waters via gravity;
pretreating the produced waters via a non-turbulent fractioning centrifuge configured to remove emulsified oil therefrom to generate de-oiled water; and
generating oil-free water from the de-oiled water via a device configured to eradicate remaining petroleum constituents and related contaminants thereby.

14. The method of claim 12, further comprising the non-turbulent fractioning centrifuge removing a high percentage of the emulsified oil from the produced waters to produce the de-oiled water.

15. The method of claim 12, further comprising generating potable water from the oil-free water via a water demineralizer.

16. The method of claim 12, further comprising utilizing waste heat from an onsite electricity generation to facilitate demineralizing the oil-free produced water by a vapor condensation process.

17. The method of claim 12, further comprising locating a site located for performing the method at the aggregate tank battery configured to collect raw fluids from a plurality of wells and pipelines and separate crude oil and produced waters via gravity.

18. The method of claim 12, further comprising pumping the raw fluids from a plurality of well sites to a site for the separating and processing of the oilfield produced water.

19. The method of claim 12, further comprising separating crude oil and produced waters via gravity and collecting produced water for onsite remediation and collecting crude oil for an onsite generation of electricity.

20. The method of claim 12, further comprising separating a heavier component from a lighter component within the raw fluids via a non-turbulent fractioning centrifuge comprising a stack of driven flat discs, a separator chamber, a disc shaft rotator, a first outlet for the heavier component and a second outlet for the lighter component and a feed pump that supplies the raw fluids to the separator, a relative closeness of the discs and a friction relationship between the fluids and a disc surface creating boundary layer conditions adapted for preventing the local churning of the fluids while moving through the machine.
